(19) United States
(12) Patent Application Publication
(10) Pub. No.: US 2013/0120642 A1
(43) Pub. Date: May 16, 2013

(54) DIGITAL PHOTOGRAPHING APPARATUS AND METHOD OF CONTROLLING THE SAME

(71) Applicant: Dong-min KIM, Suwon-si (KR)

(72) Inventor: Dong-min KIM, Suwon-si (KR)

(73) Assignee: Samsung Electronics Co., Ltd., Suwon-si (KR)

(21) Appl. No.: 13/569,338

(22) Filed: Aug. 8, 2012

(30) Foreign Application Priority Data
Nov. 11, 2011 (KR) 10-2011-0117780

(51) Int. Cl. H04N 5/232

(52) U.S. Cl. 348/349; 348/E05.045

(57) ABSTRACT

A digital photographing apparatus and a method of controlling the same. According to the method of controlling a digital photographing apparatus, when an image of a portion of an area is expanded for display for manual focusing, an image of the entire area and the expanded image are displayed simultaneously so that the user is able to determine which part of the entire image is currently being focused on. Thus, user convenience may be improved.

### CROSS-REFERENCE TO RELATED PATENT APPLICATION

This application claims the benefit of Korean Patent Application No. 10-2011-0117780, filed on Nov. 11, 2011, in the Korean Intellectual Property Office, the disclosure of which is incorporated herein in its entirety by reference.

### BACKGROUND

Embodiments of the invention disclosed herein generally relate to a digital photographing apparatus and a method of controlling the same.

Many currently released digital cameras support an auto-focusing (AF) method in which a focus is adjusted automatically. In an AF method, when a shutter button is half-pressed, a camera automatically measures a distance between the camera and a subject to appropriately adjust a focus, and thus an AF method is used in nearly every product ranging from single-lens reflex (SLR) cameras for experts to portable compact cameras.

However, in cases where there is insufficient light such as at night or indoors, an AF function may not be properly performed and may cause inconvenience. Also, if a fast-moving object is to be photographed, and an AF speed is not sufficiently high therefor, a user may miss an image-taking moment. Thus, if AF is not properly performed due to an insufficient amount of light or if a user wants to adjust a focus quickly with his eyes, a manual focusing (MF) function may be used to adjust a focus manually.

### SUMMARY

Various embodiments of the invention provide a digital photographing apparatus that simultaneously displays an image of an entire area and an image of a portion of the entire area when the image of the portion is expanded for display for manual focusing, and in which an imaging device is configured to individually generate the entire image and the expanded image in order to clearly display the entire image and the expanded image.

An embodiment of the invention also provides a method of controlling the digital photographing apparatus.

According to an embodiment, there is provided a method of controlling a digital photographing apparatus, the method comprising: displaying a first image obtained by using an image device; performing manual focusing on the first image; obtaining a second image by using the imaging device according to the manual focusing; and displaying the obtained second image.

The first image may be overlapped with the second image.

The first image may be displayed in a first display area, and the second image may be displayed in a second display area, wherein the first display area is movable with respect to the second display area.

The method may further comprise stopping the display of the first image.

A guide line may be displayed on the first image to indicate an area in which the second image is located.

The first image and the second image may be generated by being sequentially read from the imaging device.

The first image and the second image may be generated by being simultaneously read from the imaging device.

The second image may be generated by reading more pixels from the imaging device than from the first image.

The first image may be generated by reading pixels which is performed by reading one pixel in each of a vertical direction and a horizontal direction of the imaging device and skipping four lines, and the second image may be generated by reading pixels which is performed by reading two pixels in each of the vertical direction and the horizontal direction and skipping two lines.

The first image may be a live view image.

The second image may be an expanded image for focusing on a predetermined area of the first image.

The imaging device may be a complementary metal oxide semiconductor (CMOS) image sensor.

According to another embodiment, there is provided a method of controlling a digital photographing apparatus, the method comprising: reading a first image data for a live view image from an imaging device; selecting a focusing area for manual focusing from the live view image; reading a second image data corresponding to the focusing area from the imaging device; generating a first image by performing a first image processing on the first image data and generating a second image by performing a second image processing on the second image data; and displaying the generated first and second images.

The first image and the second image may be displayed by overlapping the first image and the second image.

The first image processing and the second image processing may be performed in parallel.

The first image data and the second image data may be read sequentially or simultaneously from the imaging device.

According to another embodiment, there is provided a non-transitory recording medium having a computer readable program therein, the computer readable program code adapted for executing the method described above on a computer.

According to another embodiment, there is provided a digital photographing apparatus comprising: an imaging device; and a control unit that controls the apparatus such that manual focusing is performed on a first image that is obtained by using the imaging device, that a second image is obtained by using the imaging device according to the manual focusing, and that the first image and the second image are respectively displayed in a first display area and a second display area.

The control unit may control such that first image data for generating the first image and second image data for generating the second image are read sequentially or simultaneously from the imaging device.

The control unit may perform image processings with respect to the first image data and the second image data in parallel.

### BRIEF DESCRIPTION OF THE DRAWINGS

The above and other features and advantages of the invention will become more apparent by describing in detail exemplary embodiments thereof with reference to the attached drawings in which:

FIG. 1 is a block diagram illustrating a digital camera as an example of a digital photographing apparatus according to an embodiment of the invention;

FIGS. 2A and 2B are schematic views illustrating a digital camera with a manual focusing according to the conventional art;

FIG. 3 is a schematic view illustrating a control unit illustrated in FIG. 1 according to an embodiment of the invention;

FIG. 4 is a schematic view illustrating the control unit illustrated in FIG. 1 according to another embodiment of the invention;

FIGS. 5 through 7 are schematic views for explaining reading of pixels from an imaging device according to an embodiment of the invention;

FIGS. 8A through 8D are schematic views for explaining displaying of an entire image and an expanded image according to an embodiment of the invention; and

FIG. 9 is a flowchart illustrating a method of controlling a digital photographing apparatus according to an embodiment of the invention.

### DETAILED DESCRIPTION

As used herein, the term “and/or” includes any and all combinations of one or more of the associated listed items. Expressions such as “at least one of,” when preceding a list of elements, modify the entire list of elements and do not modify the individual elements of the list.

The various embodiments of the invention will now be described more fully with reference to the accompanying drawings, in which exemplary embodiments of the invention are shown. As a digital image processing apparatus according to the present embodiment, a digital camera will be described below. However, the digital image processing apparatus is not limited to a digital camera, and digital devices such as digital camcorders, personal digital assistants (PDAs), and smartphones may also be applied as the digital photographing apparatus.

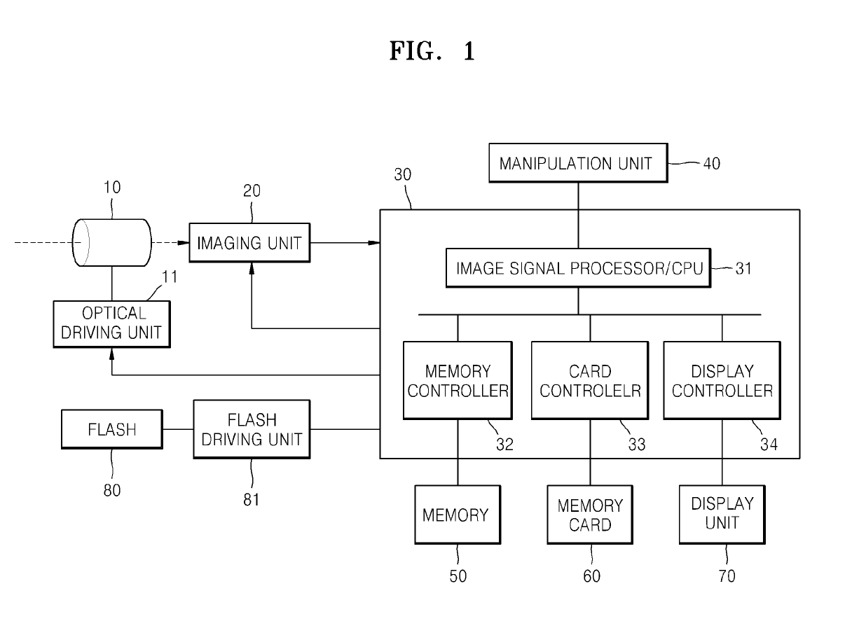

FIG. 1 is a block diagram illustrating a digital camera as an example of a digital photographing apparatus according to an embodiment of the invention.

Referring to FIG. 1, the digital camera includes an optical unit 10, an optical driving unit 11 for driving the optical unit 10, an imaging unit 20, a memory 50, a memory card 60, and a display unit 70.

The optical unit 10 includes an imaging optical system for collecting an optical signal from a subject, a shutter, and an aperture. The imaging optical system includes a focusing lens for adjusting a focus and a zoom lens for adjusting a focal length.

The optical driving unit 11 may include a focusing lens driving unit for adjusting a position of the focusing lens, an aperture driving unit for adjusting a closing degree of the aperture, and a shutter driving unit for adjusting the opening or closing of the shutter.

The imaging unit 20 includes an imaging device that captures image light that has passed through the imaging optical system of an exchangeable lens to generate an image signal. The imaging device may include a plurality of photoelectric converting units arranged in a matrix and a vertical and/or horizontal transmission passage that is synchronized with a timing signal and through which charges are moved from the photoelectric converting units to derive an image signal. As the imaging device, a complementary metal oxide semiconductor (CMOS) sensor may be used.

Also, the digital camera includes a camera control unit 30. The camera control unit 30 includes an image signal processor/CPU 31.

The image signal processor/CPU 31 may calculate auto white balance (AWB) evaluation values for controlling white balance, auto exposure (AE) evaluation values for controlling exposure, and auto focusing (AF) evaluation values for adjusting a focus, using a signal obtained from the imaging unit 20, and may appropriately control white balance, exposure, and auto-focus according to the calculated evaluation values. Also, the image signal processor/CPU 31 may perform various application operations such as object recognition (e.g., face recognition) or scene recognition with respect to an input image signal. Also, image processing for storage of records and image processing for displaying may be performed. Image processing such as gamma correction, color filter array interpolation, color matrix, color correction, color enhancement, or the like may be performed. Also, to store records, compression of a Joint Photographic Experts Group (JPEG) format or a Lempel-Ziv-Welch (LZW) format may be performed.

In addition, the camera control unit 30 may include a memory controller 32, a card controller 33, and a display controller 34.

The memory controller 32 may temporarily store captured images or other various pieces of information in the memory 50 or may output captured images or various pieces of information from the memory 50. In addition, the memory controller 32 may read program information stored in the memory 50. The memory 50 may be a buffer memory that temporarily stores captured images or various pieces of information, and may include a dynamic random access memory (DRAM), a static DRAM (SDRAM), or the like. Also, the memory 50 may include a flash memory, a read only memory (ROM), or the like, as a storage unit for storing programs.

The card controller 33 may store or read image files in or from the memory card 60. The card controller 33 may control reading and storage of not only image files but also various pieces of information. The memory card 60 may be, for example, a Secure Digital (SD) card. While the memory card 60 is described as an example of a storage medium according to an embodiment of the invention, the storage medium is not limited thereto. Image files and various pieces of information may also be stored by using optical disks (compact disk (CD), digital versatile disk (DVD), blu-ray disc, etc.), optical magnetic disks, or magnetic disks. When recording media such as optical disks (CD, DVD, blu-ray discs, etc.), optical magnetic disks, or magnetic disks are used, the card controller 33 may further include a reading device for the recording media.

Also, the display controller 34 may control image display of the display unit 70. The display unit 70 may be a liquid crystal display (LCD), an organic light-emitting display (OLED), or the like.

In addition, the digital camera includes a manipulation unit 40 through which a manipulation signal from a user is inputted. The manipulation unit 40 may include a member for the user to manipulate the digital camera or to perform various setups. For example, the manipulation unit 40 may be implemented in various forms such as a button, a key, a touch panel, a touch screen, or a dial, and various user manipulation signals such as power on/off, photographing start/stop, replay start/stop/search, driving of an optical system, mode conversion (e.g., execution of a video recording mode), menu manipulation, selection manipulation, etc. may be input through the manipulation unit 40. For example, a shutter button may be half-pressed, completely pressed, or released by the user. A focusing control start manipulation signal may be outputted by half-pressing the shutter button (operation S1), and by releasing the half-pressed shutter button, focusing control is ended. By completely pressing the shutter button (operation S2), a photographing start manipulation signal may be outputted. The manipulation signal may be transmitted to the image signal processor/CPU 31 to thereby drive a corresponding element.

In addition, the digital camera further includes a flash 80 and a flash driving unit 81. The flash 80 is used to illuminate a subject when capturing an image of the subject outdoors at night or in dark spaces. When performing flash photographing, a lighting command is transmitted from the image signal processor/CPU 31 to the flash driving unit 81, and the flash driving unit 81 drives lighting of the flash 80 in response to the lighting command. Also, the flash 80 may perform pre-lighting with which light of the subject to be photographed may be measured, in order to calculate an amount of lighting for main lighting or a time period for main lighting according to the lighting command of the image signal processor/CPU 31. Here, a xenon flash is used as the flash 80. A lighting time of the xenon flash is short but emits relatively greater amount of light than an LED and is thus frequently used in digital cameras. The flash 80 performs preliminary lighting to determine a lighting time for main lighting according to an image signal obtained from the preliminary lighting.

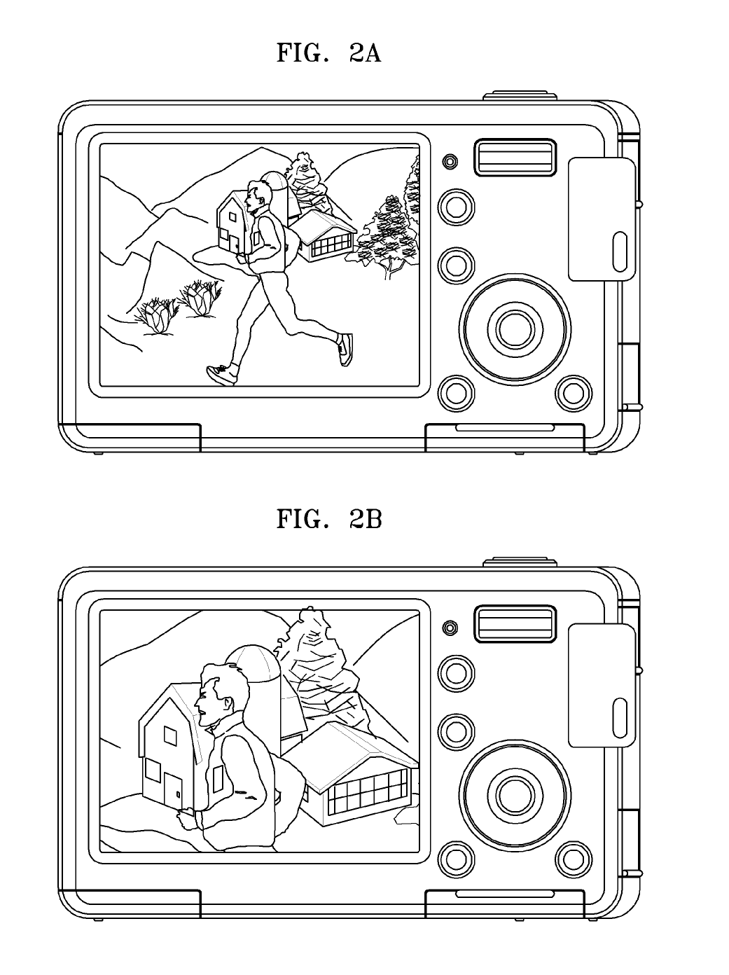

FIGS. 2A and 2B are schematic views illustrating a digital camera with a manual focus according to the conventional art.

The digital camera according to the conventional art supports manual focus and provides a manual expansion function or a manual focus assist function. Referring to FIG. 2A, a live view image of an area including a subject to be captured is displayed, and when a predetermined button or a dial is inputted by the user for conversion from AF to MF, that is, for manual focusing, an image expanded by the user of a portion of the entire area that is to be focused on is displayed, as illustrated in FIG. 2B. However, in this case, since only the expanded image is displayed, it is difficult to check which part of the entire image is expanded and currently being viewed by the user. Also, it is impossible to observe a change in the entire image, for example, any moving object shown in the entire image but not shown in the expanded image.

According to a method of controlling a digital photographing apparatus according to the current embodiment, when an image of a portion of an entire area is expanded for display for manual focusing, an image of the entire area and the expanded image are displayed simultaneously so that the user is able to determine which part of the entire image is currently being focused on. Thus, user convenience is increased. Also, an imaging device is configured to individually generate an entire image and an expanded image so that the expanded image is clearly presented, and thus when manual focusing is performed, clearer images may be provided to the user.

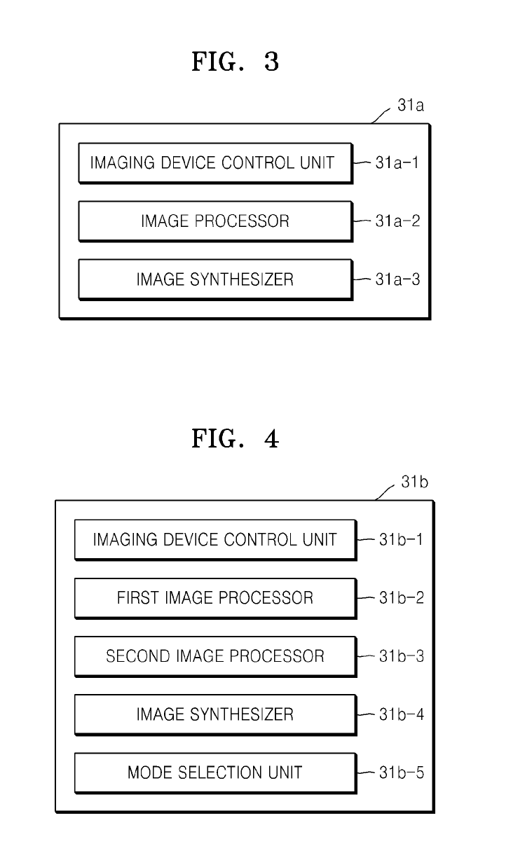

FIG. 3 is a schematic view illustrating an image signal processor/CPU 31a according to an embodiment of the invention.

Referring to FIG. 3, the image signal processor/CPU 31a includes an imaging device control unit 31a-1, an image processor 31a-2, and an image synthesizer 31a-3. The image signal processor/CPU 31a should be understood to be the same as a control unit stated in the claims.

The image signal processor/CPU 31a performs manual focusing with respect to a first image obtained by using the imaging device of the imaging unit 20, and obtains a second image by using the imaging device of the imaging unit 20 according to manual focusing. Here, the first image is a live view image, and the second image is an expanded image of an area for manual focusing.

The imaging device control unit 31a-1 reads a first image data for generating the first image and a second image data for generating the second image by using the imaging device of the imaging unit 20. Here, the first image data and the second image data may be sequentially read in a reading period of the imaging device. That is, first, the first image data may be read, and then the second image data may be read. Alternatively, the first image data and the second image data may be read simultaneously.

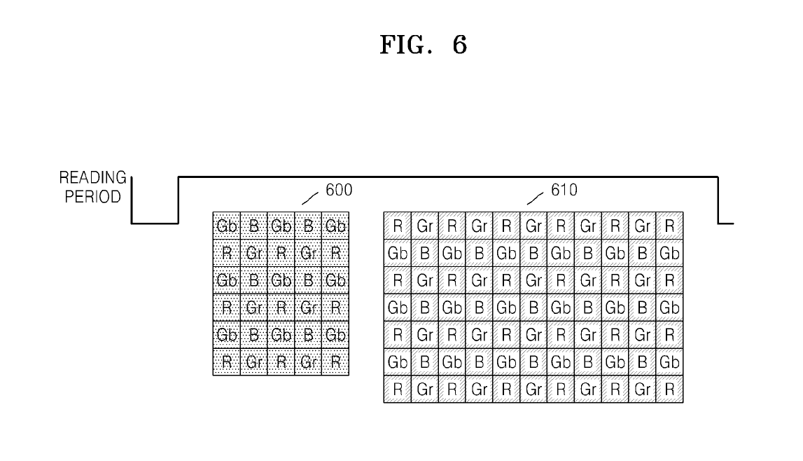

FIGS. 5 through 7 are schematic views for explaining reading of pixels from an imaging device according to an embodiment of the invention.

FIG. 5 illustrates the imaging device included in the imaging unit 20 illustrated in FIG. 1. As illustrated in FIG. 5, pixels Gb, Gr, R, and B are arranged in a checker board form over an entire surface area of the imaging device.

To generate a live view image by reading pixels, among all the pixels, one line of pixels is read and then four lines are skipped in horizontal and vertical directions. For example, a Gb pixel 500 located in a first position in FIG. 5 is read, and then four lines are skipped in the horizontal and vertical directions. Here, skipping refers to dividing a frame of an input image into lines or into pixels and then reading the image data by skipping certain data with respect to the corresponding lines or pixels.

To generate an expanded image for manual focusing by reading pixels, among all the pixels, two lines are read and then two lines are skipped in the horizontal and vertical directions. For example, four pixels 510, that is, pixels Gb, B, R, and Gr, are read as illustrated in FIG. 5, and then two lines are skipped in the horizontal and vertical directions to read next four pixels. Also, when extracting pixels for manual focusing, a number of pixels greater than that for a live view image may be extracted to provide the user with an expanded image with clearer image quality.

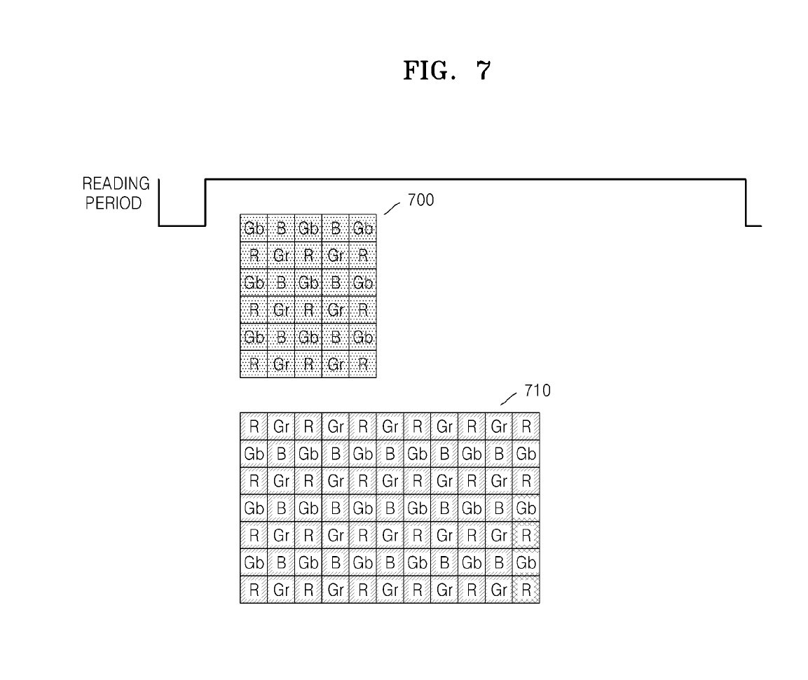

Referring to FIG. 6, during the reading period of the imaging device, first image data 600 for a live view image is first read as illustrated in FIG. 5, and then second image data 610 for manual focusing may be read. In this case, the imaging device outputs a live view image and an expanded image during a data transmission period of one frame for each of the frames. If the horizontal drive (HD) lengths of images are the same, a frame rate is determined by a length of 1 vertical drive (VD), and thus the frame rate is determined according to the size of the window from which the expanded image is outputted.

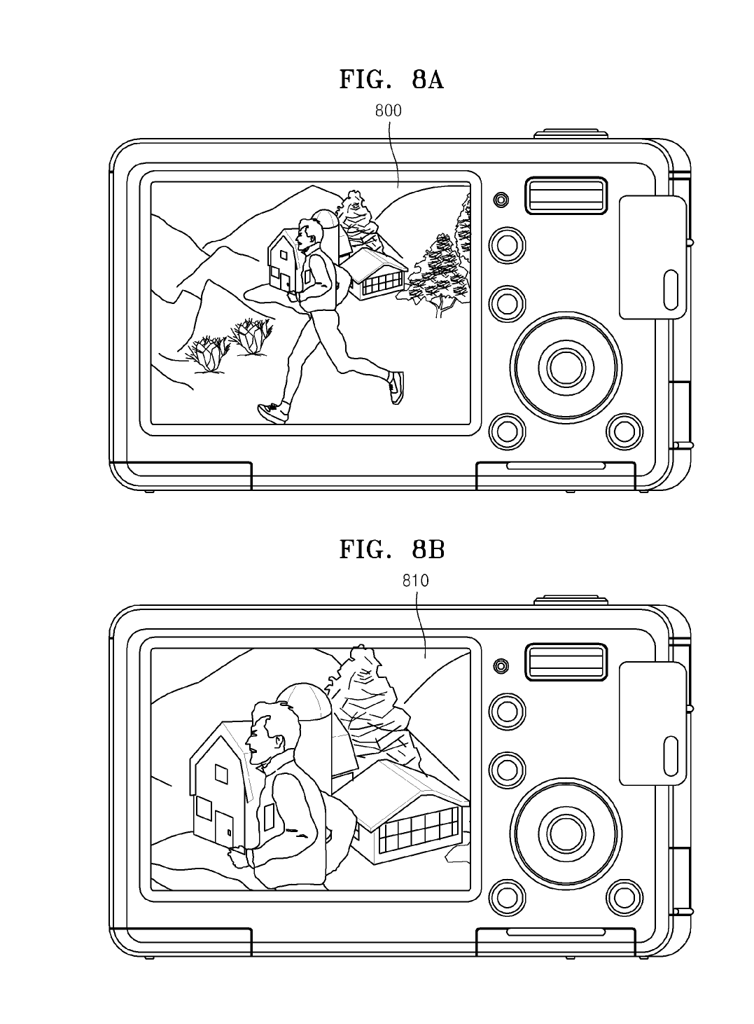

Referring to FIG. 7, during the reading period of the imaging device, as illustrated in FIG. 5, first image data 700 for a live view image and second image data 710 for an expanded image for manual focusing may be read simultaneously. In this case, the live view image and the expanded image may be outputted individually, and the image processor 31a-2, after receiving the output image data, may be controlled to perform image processing individually or in parallel.

According to the current embodiment, pixels are described with reference to a CMOS image sensor capable of pixel-by-pixel reading, but a CCD image sensor that reads line by line may also be applied here in a similar manner. Also, while pixel reading by reading one line and skipping four lines for a live view image and by reading two lines and skipping two lines for an expanded image is described above, various other reading methods may be applied according to applications of digital cameras.

The image processor 31a-2 performs image processing with respect to the first image data and the second image data. Here, different image processings may be performed on the first image data and the second image data. For example, different exposure values and white values are applied to the first image data, which is for a live view image, and the second image data, which is an expanded image for manual focusing. In addition, image processing may be performed on the first image data and the second image data in parallel. That is, a digital signal processor (DSP) for performing image processing performs a plurality of image processings during a period of time of one frame.

The image synthesizer 31a-3 synthesizes a first image generated by using the first image data and a second image generated by using the second image data to output the first image and the second image on the display unit 70 illustrated in FIG. 1.

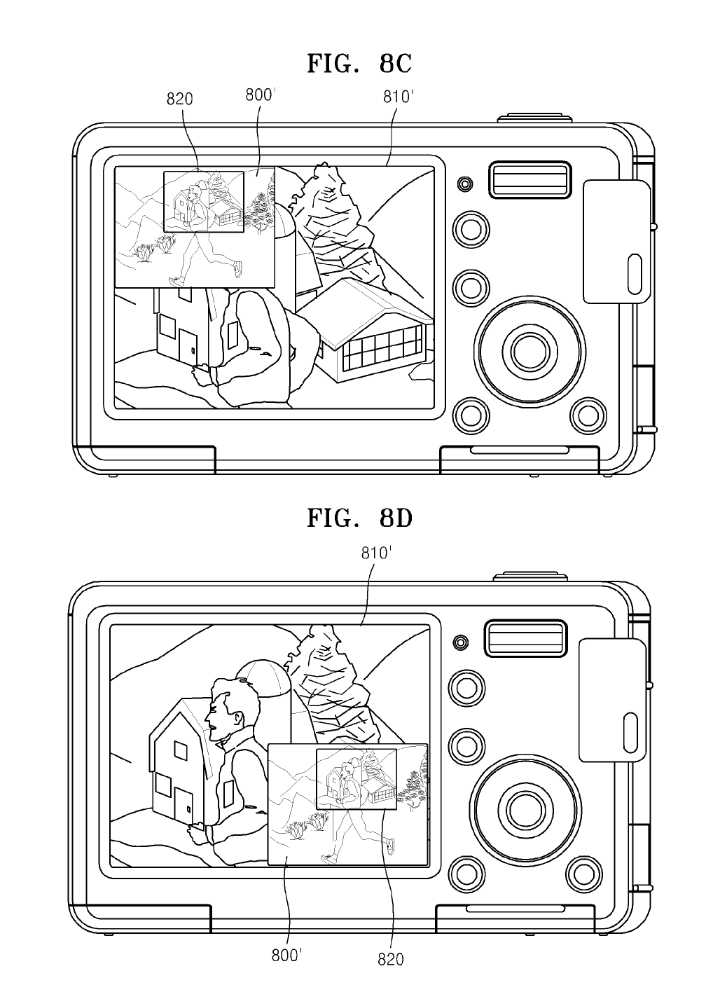

FIGS. 8A through 8D are schematic views for explaining the display of an entire image and an expanded image according to an embodiment of the invention.

The image signal processor/CPU 31a controls such that a first image and a second image are displayed together. FIG. 8A illustrates a live view image 800, and FIG. 8B illustrates an expanded image 810 displayed as manual focusing is performed. In addition, as illustrated in FIG. 8C, while an expanded image 810′ is displayed, a live view image 800′ is overlapped thereon, and also, a guide line 820 displaying a manual focusing area is also displayed on the live view image 800′. Accordingly, when an image of a portion of an area is expanded for display for manual focusing, an image of the entire area and the expanded image are displayed at the same time. Accordingly, the user may immediately check which part of the entire image is being focused on, and the imaging device is configured to individually generate the entire image and the expanded image, and thus the expanded image is clearly presented to provide an environment in which the user may easily perform manual focusing.

In addition, as illustrated in FIG. 8D, a display area in which a live view image is displayed may be moved by selection of the user. The live view image may be moved by the user by manipulating a predetermined direction key. Also, although not illustrated in the drawing, according to the selection of the user or after a predetermined period of time has passed, the live view image 800′ may disappear and only the expanded image 810′ for manual focusing may be displayed.

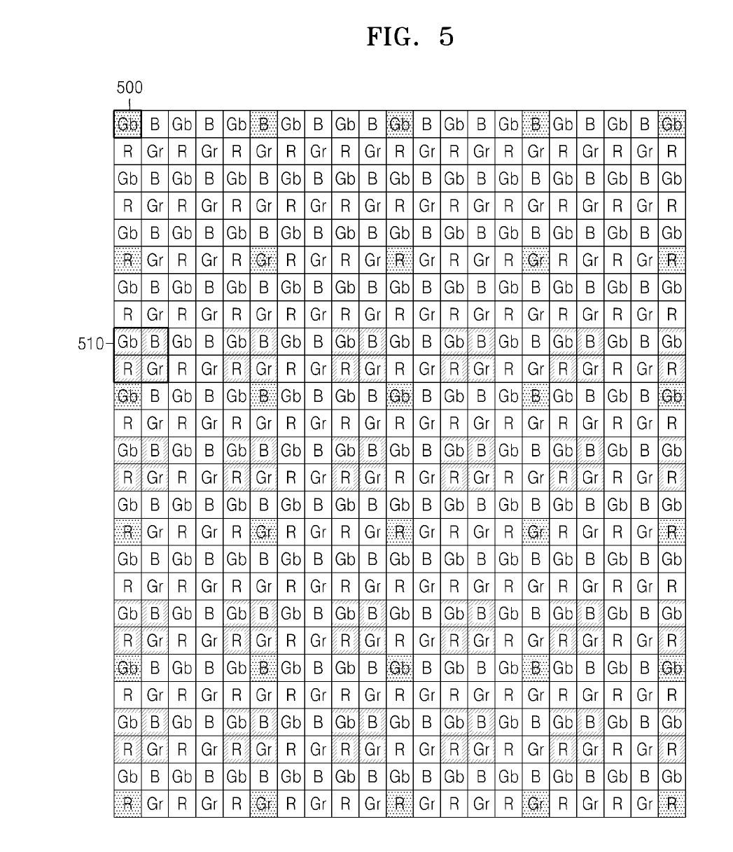

FIG. 4 is a schematic view illustrating an image signal processor/CPU 31b illustrated in FIG. 1 according to another embodiment of the invention.

Referring to FIG. 4, the image signal processor/CPU 31b includes an imaging device control unit 31b-1, a first image processor 31b-2, a second image processor 31b-3, an image synthesizer 31b-4, and a mode selection unit 31b-5. Here, the description will focus on the differences of the image signal processor/CPU 31b from the image signal processor/CPU 31a illustrated in FIG. 3.

The image signal processor/CPU 31b illustrated in FIG. 4 includes the first image signal processor 31b-2 and the second image signal processor 31b-3, both of which perform image signal processing. That is, the image signal processor/CPU 31b illustrated in FIG. 4 is divided into the first image signal processor 31b-2, which performs image processing on a first image data to generate a live view image, and the second image signal processor 31b-3, which performs image processing on a second image data for manual focusing. As described above, image processings of the first image data and the second image data may be performed in parallel.

The mode selection unit 31b-5 extracts the second image data for an expanded image from the imaging device control unit 31b-1 if the user has selected manual focusing.

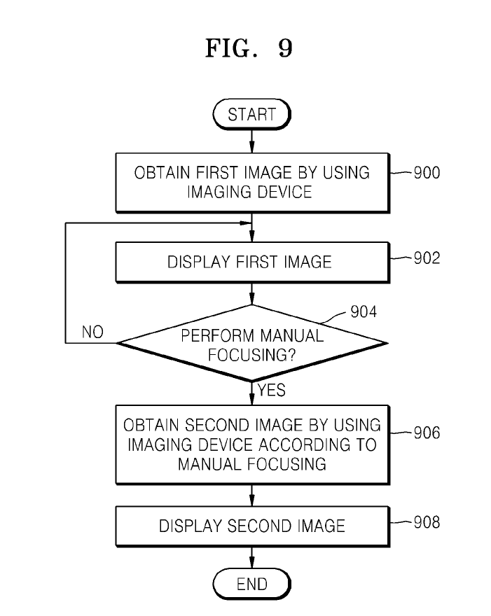

FIG. 9 is a flowchart illustrating a method of controlling a digital photographing apparatus according to an embodiment of the invention.

Referring to FIG. 9, in operation 900, a first image is obtained by using an imaging device. In operation 902, the first image is displayed.

When manual focusing is performed in operation 904, a second image is obtained by using the imaging device to provide an area that is being manually focused on according to manual focusing operation, as an expanded image in operation 906.

In operation 908, the second image is displayed.

In this operation, while displaying the second image, the first image is also displayed such that it overlaps the second image. Also, a guide line that displays a predetermined area of the first image, that is, the position of the manual focusing area, may also be displayed on the first image.

According to the method of controlling a digital photographing apparatus of the embodiments of the invention, when an image of a portion of an entire area is expanded for display for manual focusing, an image of the entire area and the expanded image are displayed simultaneously so as to inform a user about which portion of the entire image is currently being focused on. Thus, user convenience may be increased.

In addition, by configuring the imaging device to individually generate an entire image and an expanded image and to provide the entire image and the expanded image, the expanded image is clearly presented, and thus clearer images may be provided to a user when manual focusing is performed.

The device described herein may comprise a processor, a memory for storing program data and executing it, a permanent storage such as a disk drive, a communications port for handling communications with external devices, and user interface devices, including a display, keys, etc. When software modules are involved, these software modules may be stored as program instructions or computer readable codes executable on the processor on computer-readable media such as read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion. This medium can be read by a computer, stored in the memory, and executed by the processor.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The particular embodiments may be described in terms of functional block components and various processing steps. Such functional blocks may be realized by any number of hardware and/or software components configured to perform the specified functions. For example, the embodiments of the invention may employ various integrated circuit components, e.g., memory elements, processing elements, logic elements, look-up tables, and the like, which may carry out a variety of functions under the control of one or more microprocessors or other control devices. Similarly, where the elements of the embodiments are implemented using software programming or software elements, the embodiments may be implemented with any programming or scripting language such as C, C++, Java, Assembly, or the like, with the various algorithms being implemented with any combination of data structures, objects, processes, routines, or other programming elements. Functional aspects may be implemented in algorithms that execute on one or more processors. Furthermore, the embodiments of the invention could employ any number of conventional techniques for electronics configuration, signal processing and/or control, data processing, and the like. The words “mechanism” and “element” are used broadly and are not limited to mechanical or physical embodiments, but can include software routines in conjunction with processors, etc.

The particular embodiments shown and described herein are illustrative examples of the invention and are not intended to otherwise limit the scope of the invention in any way. For the sake of brevity, conventional electronics, control systems, software development, and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections, or logical connections may be present in a practical device. Moreover, no item or component is essential to the practice of the invention unless the element is specifically described as “essential” or “critical”.

The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the embodiments of the invention and does not pose a limitation on the scope of the invention unless otherwise claimed. Numerous modifications and adaptations will be readily apparent to those skilled in this art without departing from the spirit and scope of the present invention.

While the invention has been particularly shown and described with reference to exemplary embodiments thereof, it will be understood by those of ordinary skill in the art that various changes in form and details may be made therein without departing from the spirit and scope of the invention as defined by the following claims.

What is claimed is:

1. A method of controlling a digital photographing apparatus, the method comprising:
displaying a first image obtained by using an image device;
performing manual focusing on the first image;
obtaining a second image by using the imaging device according to the manual focusing; and
displaying the obtained second image.

2. The method of claim 1, wherein the first image is overlapped with the second image.

3. The method of claim 1, wherein the first image is displayed in a first display area, and the second image is displayed in a second display area, and
wherein the first display area is movable with respect to the second display area.

4. The method of claim 1, further comprising stopping the display of the first image.

5. The method of claim 1, wherein a guide line is displayed on the first image to indicate an area in which the second image is located.

6. The method of claim 1, wherein the first image and the second image are generated by being sequentially read from the imaging device.

7. The method of claim 1, wherein the first image and the second image are generated by being simultaneously read from the imaging device.

8. The method of claim 1, wherein the second image is generated by reading more pixels from the imaging device than are read for the first image.

9. The method of claim 1, wherein the first image is generated by reading pixels which is performed by reading one pixel in each of a vertical direction and a horizontal direction of the imaging device and skipping four lines, and
the second image is generated by reading pixels which is performed by reading two pixels in each of the vertical direction and the horizontal direction and skipping two lines.

10. The method of claim 1, wherein the first image is a live view image.

11. The method of claim 1, wherein the second image is an expanded image for focusing on a predetermined area of the first image.

12. The method of claim 1, wherein the imaging device is a complementary metal oxide semiconductor (CMOS) image sensor.

13. A method of controlling a digital photographing apparatus, the method comprising:
reading a first image data for a live view image from an imaging device;
selecting a focusing area for manual focusing from the live view image;
reading a second image data corresponding to the focusing area from the imaging device;
generating a first image by performing a first image processing on the first image data and generating a second image by performing a second image processing on the second image data; and
displaying the generated first and second images.

14. The method of claim 13, wherein the first image and the second image are displayed by overlapping the first image and the second image.

15. The method of claim 13, wherein the first image processing and the second image processing are performed in parallel.

16. The method of claim 13, wherein the first image data and the second image data are read in a manner that is at least one of sequential and simultaneous from the imaging device.

17. A non-transitory computer program product, comprising a computer usable medium having a computer readable program code embodied therein, the computer readable program code adapted to be executed to implement the method of claim 1.

18. A digital photographing apparatus comprising:
an imaging device; and
a control unit that controls the apparatus such that manual focusing is performed on a first image that is obtained by using the imaging device, that a second image is obtained by using the imaging device according to the manual focusing, and that the first image and the second image are respectively displayed in a first display area and a second display area.

19. The digital photographing apparatus of claim 18, wherein the control unit controls the apparatus such that a first image data for generating the first image and a second image data for generating the second image are read in a manner that is at least one of sequential and simultaneous from the imaging device.

20. The digital photographing apparatus of claim 19, wherein the control unit performs image processings with respect to the first image data and the second image data in parallel.
